(19) United States
(12) Patent Application Publication
(10) Pub. No.: US 2004/0068424 A1
(43) Pub. Date: Apr. 8, 2004

(54) System and method for managing workflow among members of an organization

(76) Inventors: Chung-I Lee, Tu-chen (TW); Floye Lin, Shenzhen (CN); Benson Luo, Shenzhen (CN); Yekoo Wang, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/404,686

(22) Filed: Mar. 31, 2003

(30) Foreign Application Priority Data
Oct. 4, 2002 (TW) 91122973

(51) Int. Cl. G06F 17/60

(52) U.S. Cl. 705/7

(57) ABSTRACT

A workflow management system for processing documents and correlative information among a plurality of various departments of an organization includes: a workflow management server (10) for processing communication of documents and correlative information, and for monitoring a status of current workflow; a database (60) linked with the workflow management server, for storing information for processing and monitoring of workflow; a plurality of client computers (30); a file server (70); a network (20) interconnecting the workflow management server, the client computers and the file server; and a workflow management program (40) installed in the workflow management server. The workflow management program includes a role/character management module (41), a workflow selection module (42), a workflow step determination module (43), a character assignment module (44), a communication module (45), and a web interface module (48).

### BACKGROUND OF THE INVENTION

1. Field of the Invention

The present invention generally relates to an electronic workflow management system and method, and more particularly to a workflow management system and method for processing documents and correlative information among a plurality of members of various departments of an organization.

2. Description of Related Art

In a large organization, processing documents and correlative information is frequently an intricate and complicated process involving numerous activities that must be completed by various departments. Many of these activities depend on one another, in that one activity cannot begin until other activities have been completed. This interdependency among activities and various departments makes it difficult to process cases in an economical and efficient manner.

Conventionally, processing documents and correlative information is a largely manual process. Documents and correlative information on a case are manually transferred from one department to the next department as tasks on the case are completed. The formal handover of the case and accompanying instructions to perform the next tasks are generally accomplished via e-mail, electronic messages and the like. It is commonplace for a department to receive little or no advance notice about a new task before the instructions arrive. The department therefore has little or no time to plan and prepare for the activities involved.

Furthermore, if a task is held up in a department, it is often difficult to determine the reasons for delay and the identities of the persons who are responsible for the delay. An officer may only find out about a delay when he/she examines a case whose deadline has passed. When this happens, it is too late to try to remedy the delay.

In the view of the above, what is needed is an efficient and economical system and method for processing cases of an organization, and for managing and tracking workflow associated with processing of case documents and correlative information among a plurality of various departments of the organization.

A typical modern business workflow management system improves the efficiency of manual processing of documents and associated intercommunication among departments by processing and transmitting electronic documents and correlative information via a distributed computer network. A standard workflow is established, comprising communication steps and rules of business processing as defined by users of the system. For each workflow step, the system automatically sends electronic documents and correlative information to appropriate departments according to predefined rules. A network administrator is needed to take charge of storing and modifying the predefined steps and rules.

Generally, the above-described typical workflow management system generates a lot of similar predefined steps, rules and information. These data use up large amounts of electronic storage space, and provides unduly large amounts of work for administrators.

To sum up, what is needed is an efficient and economical system and method for managing and tracking workflow and for easily modifying workflow procedures. Any such system and method should be able to be employed in distributed offices of large enterprises.

### SUMMARY OF THE INVENTION

Accordingly, one objective of the present invention is to provide a system and method for efficiently managing workflow involving processing and transmission of documents and correlative information, and for monitoring a status of current workflow via a distributed computer network.

Another objective of the present invention is to provide a system and method for managing workflow which allows easy modification of predefined workflows to define a new similar workflows.

To achieve the objects set out above, in one aspect of the present invention, a method is provided for managing workflow involving processing of documents and correlative information among a plurality of various departments via a distributed computer network. The method comprises the steps of: (a) sending information on a new task to a workflow management program; (b) receiving the new task information from an original computer; (c) selecting a most suitable workflow for processing the task from a plurality of workflows by accessing a database; (d) setting up a specific case to record information on processing of each of steps of the workflow; (e) determining a current workflow step based on workflow step information of case information and on a definition of the workflow; (f) selecting a character to perform a role needed by the current workflow step, based on a corresponding role/character relationship; (g) sending a message notifying the character to perform the current workflow step; (h) receiving a completion message for the current workflow step; and (i) if the current workflow step is not the final step of the workflow, returning to step (e) until the final step is completed.

In another aspect of the present invention, a system is provided for managing workflow involving processing of documents and correlative information among a plurality of various departments of an organization. The system preferably comprises: a workflow management server for processing communication of documents and correlative information, and for monitoring a status of current workflow; a database linked with the workflow management server, for storing information for processing and monitoring of workflow; a plurality of client computers; a file server; and a network interconnecting the workflow management server, the client computers and the file server. A workflow management program is installed in the workflow management server, and comprises: a role/character management module for storing a plurality of role definitions and a plurality of characters in the database; a workflow selection module for selecting an appropriate workflow from a range of workflows stored in the database, and for setting up a specific case to record information on processing of each of steps of the workflow; a workflow step determination module for assessing workflow step information of case information and a definition of the workflow, and for determining a current workflow step, wherein information on each of the workflow steps comprises a step serial number, a serial number of a step preceding the step except where the step is a first step, and a role needed to perform the step; a character assignment module for selecting a character to perform a corresponding role needed by the current workflow step; a communication module for sending a message to the client computer of the selected character notifying him/her to perform the current workflow step, and for receiving a completion message for the current workflow step; and a web interface module for providing operating interfaces for the client computers to access case information, modify roles that respective workflows need, send information on new tasks and current workflow step completion messages as needed, and upload and download documents. The file server is for storing documents set up for each of the workflow steps and documentary information electronically filed during performance of the workflow steps, and for processing requests for uploading and downloading sent by the web interface module.

Other objects, advantages and novel features of the present invention will be drawn from the following detailed description of the present invention with the attached drawings, in which:

### BRIEF DESCRIPTION OF THE DRAWINGS

FIG. 1 is a block diagram of infrastructure of a workflow management system in accordance with a preferred embodiment of the present invention, the system comprising a workflow management server, a database, a plurality of client computers (only one shown), a file server, and a network;

FIG. 2 is a block diagram of modules of a workflow management program of the workflow management server of FIG. 1, also showing connection of the workflow management program with the database, one client computer and the file server;

FIG. 3 is a flow diagram of a procedure for processing documents and corresponding information among a plurality of various members of an organization, the procedure being implemented in accordance with a preferred workflow management method of the present invention; and

FIG. 4 is a flow chart of a preferred method for managing workflow in accordance with the present invention.

### DETAILED DESCRIPTION OF THE INVENTION

Reference will now be made to the drawing figures to describe the present invention in detail.

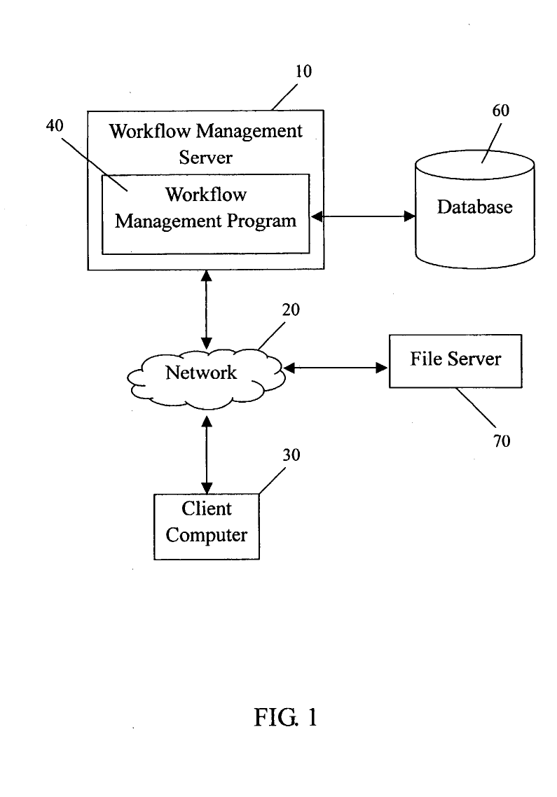

FIG. 1 is a block diagram of infrastructure of a workflow management system in accordance with a preferred embodiment of the present invention. The workflow management system comprises a workflow management server 10, a database 60 linked with the workflow management server 10, a plurality of client computers 30 (only one shown), a file server 70, and a network 20 interconnecting the workflow management server 10, the client computers 30 and the file server 70. The workflow management server 10 is for processing communication of documents and correlative information, and for monitoring a status of current workflow. All this is performed by operation software installed in the workflow management server 10, and via the network 20. Said operation software comprises a workflow management program 40. The database 60 is for storing information for monitoring and processing of workflow, and comprises a database management system. The database management system may be a relational database system needed to implement the database 60. The client computers 30 are for processing daily business activities. The file server 70 is for storing documents set up for each of workflow steps, and documentary information electronically filed during performance of the workflow steps. Users at the client computers 30 can upload and download documents to and from the file server 70. The network 20 may be a LAN (Local Area Network), a WAN (Wide Area Network), a hybrid network, or any other similar kind of computer network such as an intranet which comprises a plurality of LANs assembled via routers or small switches.

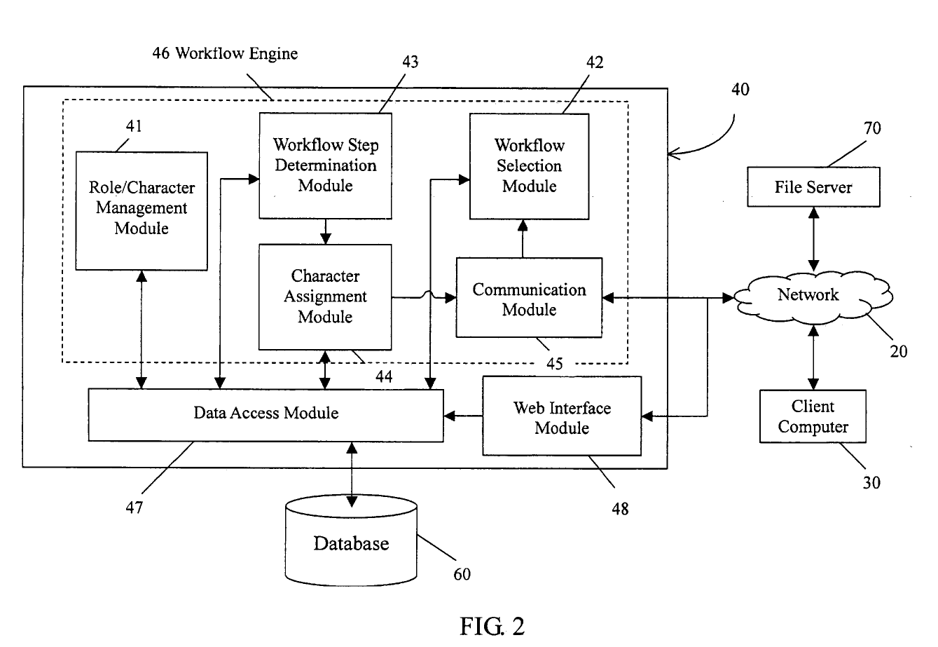

FIG. 2 is a block diagram of modules of the workflow management program 40 of the workflow management server 10, also showing connection of the workflow management program 40 with the database 60, one client computer 30 and the file server 70. The workflow management program 40 is implemented using the XML (eXtensible Markup Language) Web service of Microsoft.net. The XML Web service is defined as an element of software, is inserted by SOAP (Simple Object Access Protocol), and logs in UDDI (Universal Description, Discovery and Integration) according to WSDL (Web Service Definition Language). The XML Web service components can implement intercommunication among applications whatever language the applications are written in, whatever operating system the applications run on, and whatever apparatus the applications are accessed by. Further, the XML Web service components are independent of each other, and can be assembled together to implement a desired software function. The software function can operate across different platforms, can expand easily to develop systems with the use of a .net configuration, and can be adapted to build a working platform for a distributed computer network to accomplish coordinated workflow management among a plurality of various members of an organization.

With a three-tier configuration, the workflow management program 40 respectively comprises a web interface module 48, a workflow engine 46 and a data access module 47. The workflow engine 46 comprises a role/character management module 41, a workflow selection module 42, a workflow step determination module 43, a character assignment module 44 and a communication module 45. As described above, because the workflow management program 40 is implemented with the use of the XML Web service, the modules can be written in a variety of different languages and intercommunicate via XML.

To support access by web browsers running on the client computers 30, the web interface module 48 of the workflow management module 40 can be implemented with ASP.net and C++ programming. Corresponding to the role/character relationship definition, the web interface module 48, linked together with a plurality of remote client computers 30 by the network 20, provides an operating interface for the client computers 30 to access case information, modify roles that respective workflows need, and send information on new tasks and current workflow step completion messages as needed. The web interface module 48 also services queries for obtaining case information within the range of authorization of each respective user, and provides uploading and downloading of documents. That is, documents filed in an earlier processing step are downloaded from the file server 70 to a relevant client computer 30. Documents just completed in a current workflow step are filed by way of uploading from a relevant client computer 30 to the file server 70.

The workflow engine 46 of the workflow management program 40 supports workflow management, and can be implement with VB.net programming to support the XML Web service. An administrator stores a plurality of definitions of workflows in the database 60 in advance, defines a plurality of roles based on the defined workflows, adds a plurality of role definitions and a plurality of characters via the role/character module 41, and then assigns the roles according to abilities, skills and needs of the characters and needs of the defined workflows. A role as described herein is tantamount to a kind of license, wherein certain activities can each be implemented to a certain extent. A character as described herein is any relevant member of the organization. Each character may have more than one role assigned to him/her. A plurality of tables is set up in the database 60 to store information on roles and characters, information on the roles that various workflows respectively need, and their corresponding interrelationships.

The communication module 45 provides communication between the workflow management server 10 and the client computers 30 via the network 20. The communication module 45 supports the XML Web service, and provides communication among different platforms via the SOAP protocol and the XML technology. That is, the communication module 45 can provide communication among any of the various client computers 30. Characters at the client computers 30 access the web interface module 48 and send information on new tasks and current workflow step completion messages to the workflow management server 10 as needed. At the same time, the client computers 30 can each run a proxy for communication. The proxy may be written solely on each of the client computers 30, or may be network communication software supported by the operating systems of the client computers 30 and the file server 70. A popular brand of network communication software is Lotus Notes.

The workflow selection module 42 communicates with the communication module 45 and the database access module 47. One client computer 30, herein described as an original client computer 30, sends information on a new task to the workflow management server 10 via the communication module 45. The original client computer 30 indicates a source of the new task information. The workflow selection module 42 is used for selecting an appropriate workflow from a range of workflows. Each workflow in the range of workflows comprises a plurality of workflow steps, and information related to each workflow step is called workflow step information. Workflow step information for all the workflows is stored in a correlative table of the database 60 in advance. Workflow step information for each workflow comprises a step serial number, a serial number of a step preceding the step, and a role needed to perform the step. The workflow selection module 42 accesses the database 60 via the database access module 47 to select an appropriate workflow based on a class of business activity as defined in the new task information, and sets up a specific case based on the new task information to record information on each step of the workflow. Case information of the specific case comprises status messages, a plurality of items of workflow step information, and correlative information of documents filed. All the case information is stored in a correlative table of the database 60. Characters can access the database 60 via the web interface module 48 to access the correlative table and thereby monitor and obtain workflow step information and documentary information filed during performance of the workflow steps.

The workflow determination module 43 intercommunicates with the character assignment module 44 and the database access module 47. The workflow determination module 43 accesses the database 60 via the database access module 47. Based on the status messages contained in the case information of a specific case, the workflow determination module 43 accesses case information for processing and a correlative workflow definition. The workflow determination module 43 assesses the workflow step information of the case information and the workflow definition, determines a current workflow step, and sends information on the current workflow step to the character assignment module 44.

The character assignment module 44 intercommunicates with the workflow determination module 43, the database access module 47 and the communication module 45. The character assignment module 44 receives the information on the current workflow step sent by the workflow step determination module 43. The character assignment module 44 then accesses the database 60 via the database access module 47 and, based on the corresponding role/character relationship, selects a character to perform a corresponding role needed by the current workflow step. Further, the character assignment module 44 sends a message via the communication module 45 to the client computer 30 of the selected character, notifying him/her to perform the current workflow step.

The database access module 47 and the database 60 belong to the third tier of the three-tier configuration of the workflow management program 40. The database access module 47 can function via programming with the ODBC (Open Database Connectivity) standard. The ODBC standard is the database access standard developed by Microsoft Corporation. All applications designed according to the OCBC standard can access a database via an ODBC driver, whatever database management system the database uses. Thus whatever database management system the database 60 uses, the database 60 can be accessed via the database access module 47.

The working theory of the above-described modules 41-45, 47-48 of the workflow management program 40 will hereinafter be described in detail from the point of view of one character.

First, the administrator predefines a plurality of roles via the role/character management module 41, and then assigns the roles according to abilities, skills and needs of the characters and needs of the workflows. The correlative information is formed into a table, and is stored in the database 60.

Secondly, the web interface module 48 provides an operating interface for each character, based on one or more roles assigned to that character.

Thirdly, the communication module 45 supports communication between the workflow management server 10 and the client computers 30. Characters can access the web interface module 48 to send messages to the workflow management server 10, and can receive messages sent by a proxy network communication server that supports network communication software, such as a Lotus Notes server.

Fourthly, the workflow management selection module 42, based on a business activity class of received information on a new task, automatically selects a workflow to process the new task and sets up a specific case for the workflow in order to record information on processing of steps of the workflow. Said information is formed into a table, which is stored in the database 60.

Fifthly, the workflow determination module 43 determines a current workflow step based on the case information and the corresponding workflow definition, and sends information on the current workflow step to the character assignment module 44.

Sixthly, the character assignment module 44, based on the role needed by the current workflow step, selects a character for performing the needed role. The character assignment module 44 then sends a message via the communication module 45 notifying the selected character to perform the current workflow step.

Finally, after receiving the notification, the character accesses the web interface module 48 to obtain relevant workflow information and download documents filed in the previous workflow step from the file server 70. After performing the current workflow step, the character accesses the web interface module 48 to send completion information on the current workflow step to the workflow management server 10, and to upload needed documents to the file server 70.

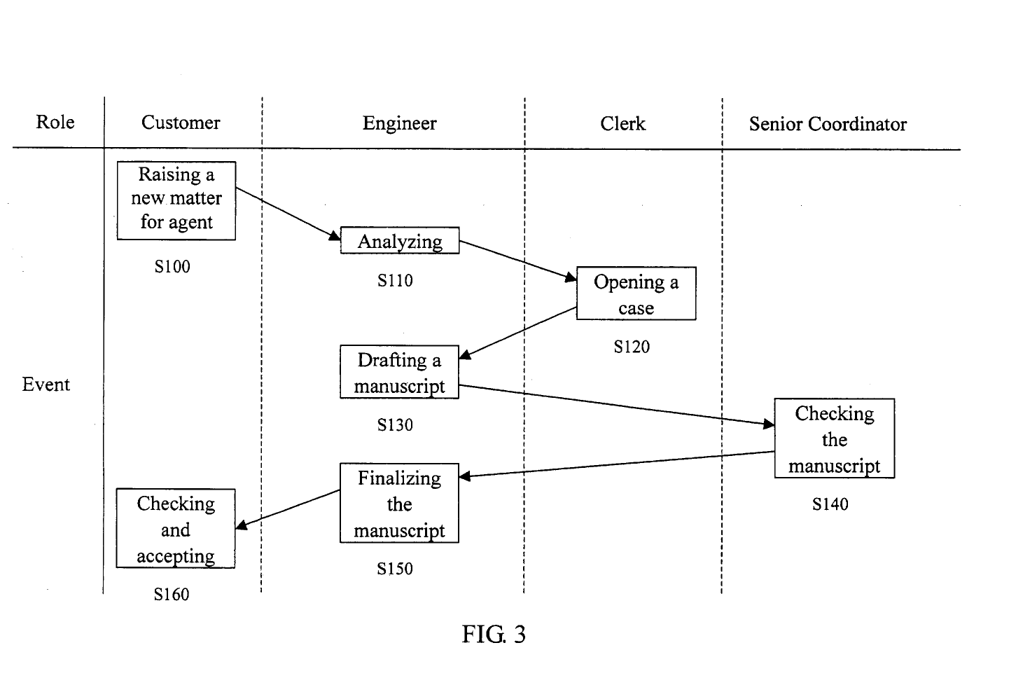

FIG. 3 is a flow diagram of a procedure for processing documents and corresponding information among a plurality of various members of an organization, the procedure being implemented in accordance with a preferred workflow management method of the present invention. In this exemplary procedure, the organization is a patent office that has a business process requiring five different characters: a customer, an agent, an engineer, a clerk, and a senior coordinator. The business process comprises six events: the customer raising a new matter requiring the attention of the agent (Step S100), the engineer analyzing the matter (Step S110), the clerk opening a case for processing regarding the matter (Step S120), the engineer drafting a manuscript (Step S130), the senior coordinator checking the manuscript (Step S140), the engineer finalizing the manuscript (Step S150), and the customer checking and accepting the manuscript (Step S160). All five characters can access the network 20 via respective client computers 30. The procedure is further described in detail as follows:

The customer raises a matter requiring the attention of the agent (Step S100):

The agent is a business representative of the patent office. The agent interviews the customer to obtain details of the matter. The agent transfers information on the matter and correlative information to the engineer who is located at the patent office via ordinary post or electronic mail.

The engineer analyzes the matter (Step S110):

The engineer is a registered patent agent of the office. The engineer is in charge of analyzing patent matters, and drafting and modifying patents. After analyzing the matter, the engineer determines that a case on the matter should be opened. The engineer inputs information on the matter via an operating interface of the web interface module 48, and sends information on a new task corresponding to the matter to the workflow management server 10 to start a workflow.

The clerk opens a case for processing regarding the matter (Step S120):

The clerk is in charge of administration of business of the office, and manages opening of cases via a query interface of the web interface module 48. When information on the matter is ready, the workflow management program 40 sends a message to the clerk notifying him/her to open a case on the matter. After opening the case, the clerk uploads needed documents to the file server 70 via the web interface module 48, and sends a completion message for the current workflow step to the workflow management server 10.

The engineer drafts a manuscript (Step S130):

The workflow management program 40 switches the workflow to the next workflow step, selects a suitable engineer, and sends the engineer a message notifying him/her to draft a manuscript. For the purposes of illustrating the procedure described herein, the suitable engineer selected is the same as the engineer described above in relation to Step S110. The engineer accesses the web interface module 48 via his/her client computer 30 to obtain correlative information regarding opening of the case. After drafting the manuscript, the engineer uploads needed documents to the file server 70 via the web interface module 48, and sends a completion message for the current workflow step to the workflow management server 10.

The senior coordinator checks the manuscript (Step S140):

The workflow management program 40 switches the workflow to the next workflow step, and sends a message to the client computer 30 of the senior coordinator notifying him/her to check the manuscript. The senior coordinator accesses the web interface module 48 via his/her client computer 30 to obtain the information on the case, and downloads the documents filed in the previous step from the file server 70. After checking and correcting the manuscript, the senior coordinator uploads needed documents to the file server 70 via the web interface module 48, and sends a completion message for the current workflow step to the workflow management server 10.

The engineer finalizes the manuscript (Step S150):

The workflow management program 40 switches the workflow to the next workflow step, and sends a message to the engineer notifying him/her to finalize the manuscript. The engineer accesses the web interface module 48 to obtain information on the case, and downloads the documents filed in the previous step from the file server 70. After finalizing the manuscript, the engineer uploads a final version of the manuscript to the file server 70 via the web interface module 48, and sends a completion message for the current workflow step to the workflow management server 10.

The customer checks and accepts the manuscript (Step S160):

The workflow management program 40 switches the workflow to the next and final workflow step, and sends a message to the customer requesting him/her to check the manuscript and accept the manuscript if it is found to be satisfactory. There are two ways in which the manuscript may be conveyed to the customer: one is by way of delivery of a hardcopy, the other is by way of access to an electronic file via the web interface module 48.

In an alternative procedure, Step S140 and S150 may essentially be repeated. That is, the senior coordinator may check the manuscript twice, and the engineer may modify/finalize the manuscript twice. In this alternative procedure, the workflow definition is a different workflow definition that incorporates the repeat steps.

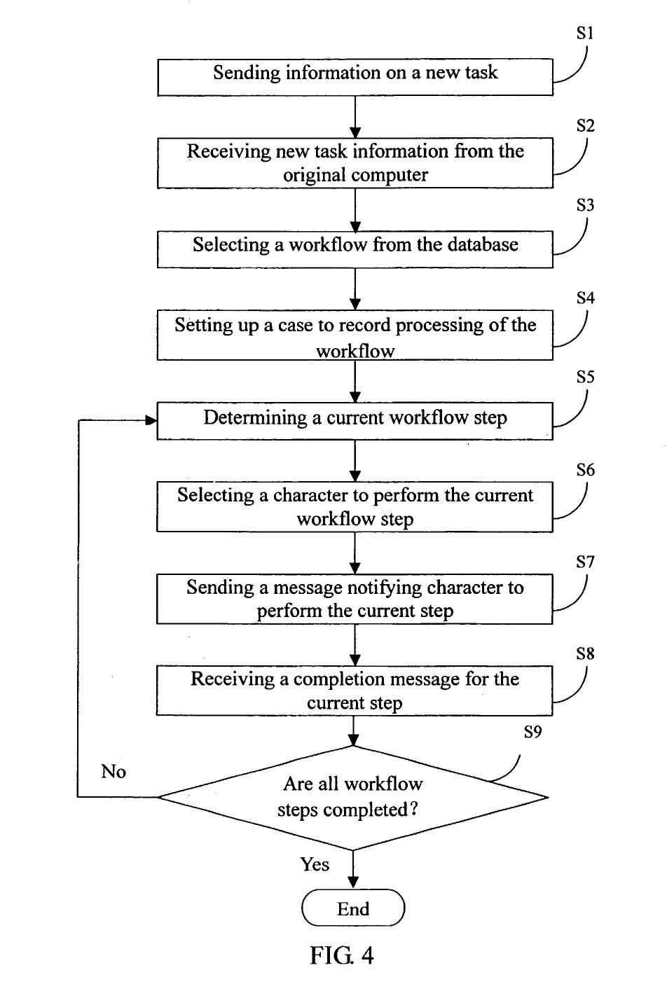

FIG. 4 is a flow chart of a preferred method for managing workflow in accordance with the present invention. It is assumed that initialization of the workflow management program 40 is complete. That is, the administrator has stored a plurality of workflow definitions in the database 60, has defined a plurality of roles based on the defined workflows, has added a plurality of role definitions and a plurality of characters via the role/character module 41, and has assigned the roles according to abilities, skills and needs of the characters and needs of the defined workflows. A character runs the web browser at his/her client computer 30 to access the web interface module 48, communicates with the workflow management server 10 via the communication module 45, and sends information on a new task to the workflow management program 40. Accordingly, said client computer 30 is referred to as the original client computer 30 (Step S1). The workflow management program 40 receives the new task information from the original client computer 30. That is, the communication module 45 transfers the new task information to the workflow selection module 42 (Step S2). The workflow selection module 42 accesses the database 60 via the database access module 47. Based on the business activity class defined in the new task information, the workflow selection module 42 selects a most suitable workflow for processing the task from a plurality of workflows. The selected workflow comprises a plurality of workflow steps. Information related to each workflow step is called workflow step information, which is stored in the correlative table of the database 60 in advance. The workflow step information comprises a step serial number, a serial number of a previous step, and a role needed by the current workflow step (Step S3). The workflow selection module 42 sets up a specific case to record information on processing of each step of the workflow. Recorded information on the case is stored in the correlative table of the database 60. Such information comprises basic status information, information on a plurality of workflow steps, and the correlative information of documents filed. Basic status information includes a name of the case, a customer name, and a name of a department of the organization that is in charge of the case (Step S4). The workflow determination module 43 accesses the database 60 via the database access module 47. Based on the basic status information of the case information, the workflow determination module 43 assesses the case information needing processing and the correlative workflow definition. The workflow determination module 43 determines the current workflow step, based on the workflow step information of the case information and on the workflow definition. The workflow determination module 43 then sends information on the current workflow step to the character assignment module 44 (Step S5). The character assignment module 44 receives the information on the current workflow step sent by the workflow step determination module 43; in particular, information on a predefined role needed by the current workflow step. The character assignment module 44 accesses the database 60 via the database access module 47, and selects a character to perform the needed role based on the corresponding role/character relationship (Step S6). Further, the character assignment module 44 sends a message via the communication module 45 to the client computer 30 of the selected character, notifying him/her to perform the current workflow step (Step S7). Upon receiving the notification, the character accesses the web interface module 48 to obtain the relevant workflow information and to download documents filed in the previous workflow step from the file server 70. After performing the current workflow step, the character accesses the web interface module 48 to send completion information for the current workflow step to the workflow management server 10, and to upload needed documents to the file server 70. The workflow management program 40 receives the completion message for the current workflow step, and the correlative information of the workflow is changed accordingly (Step S8). If the current workflow step is the final step of the workflow, the case status is set as complete (Step S9), in which case the procedure is ended. If the current step is not the final step, the case status remains as incomplete, and the procedure returns to Step S5 described above. In such case, the workflow step determination module 43 continues to process the workflow until the final step of the workflow is completed.

It is to be understood, however, that even though numerous characteristics and advantages of the present invention have been set forth in the foregoing description, together with details of the structure, function and methods of the invention, the disclosure is illustrative only, and changes may be made in detail within the principles of the invention to the full extent indicated by the broad general meaning of the terms in which the appended claims are expressed.

What is claimed is:

1. A method for managing workflow comprising the following steps:
(a) sending information on a new task to a workflow management program;
(b) receiving the new task information from an original computer;
(c) selecting a most suitable workflow for processing the task from a plurality of workflows by accessing a database;
(d) setting up a specific case to record information on processing of each of steps of the workflow;
(e) determining a current workflow step based on workflow step information of case information and on a definition of the workflow;
(f) selecting a character to perform a role needed by the current workflow step, based on a corresponding role/character relationship;
(g) sending a message notifying the character to perform the current workflow step;
(h) receiving a completion message for the current workflow step; and
(i) if the current workflow step is not a final step of the workflow, returning to step (e) until the final step is completed.

2. The method for managing workflow as described in claim 1, further comprising the step of:
providing a web interface for accessing case information, modifying roles that respective workflows need, sending information on new tasks and current workflow step completion messages as needed, and uploading and downloading documents.

3. The method for managing workflow as described in claim 1, wherein step (d) further comprises the step of:
storing the new task information in the database.

4. The method for managing workflow as described in claim 1, wherein said information in step (d) comprises workflow step information and information on correlative documents, for monitoring workflow steps, and for managing documents filed during performance of workflow steps.

5. The method for managing workflow as described in claim 1, further comprising the step of:
setting up a table in the database for storing workflow definitions, role information, character information, corresponding role/character relationships and case information.

6. The method for managing workflow as described in claim 1, wherein information on each of the workflow steps comprises a serial number of the step, and a serial number of a step preceding the step except where the step is a first step.

7. The method for managing workflow as described in claim 1, further comprising the step of:
downloading needed documents from a file server at the beginning of each of the workflow steps, and uploading needed documents to the file server at the end of each of the workflow steps.

8. The method for managing workflow as described in claim 6, wherein the documents set up by different workflows have the different display usages.

9. A system for managing workflow, the system comprising:
a workflow management server;
a plurality of client computers;
a file server;
a database linked with the workflow management server for storing information for processing and monitoring of workflow;
a network interconnecting the workflow management server, the client computers and the file server; and
a workflow management program installed in the workflow management server,
the workflow management program comprising:
a role/character management module for storing a plurality of role definitions and a plurality of characters in the database;
a workflow selection module for selecting an appropriate workflow from a range of workflows stored in the database, and for setting up a specific case to record information on processing of each of steps of the workflow;
a workflow step determination module for assessing workflow step information of case information and a definition of the workflow, and for determining a current workflow step, wherein information of each of the workflow steps comprises a step serial number, a serial number of a step preceding the step except where the step is a first step, and a role needed to perform the step;
a character assignment module for selecting a character to perform a corresponding role needed by the current workflow step;
a communication module for sending a message to the client computer of the selected character notifying the selected character to perform the current workflow step, and for receiving a completion message for the current workflow step; and
a web interface module for providing operating interfaces for the client computers to access case information, modify roles that respective workflows need, send information on new tasks and current workflow step completion messages as needed, and upload and download documents;
wherein the file server is for storing documents set up for each of the workflow steps and documentary information electronically filed during performance of the workflow steps, and for processing requests for uploading and downloading sent by the web interface module.

10. The system for managing workflow as described in claim 8, wherein each of the roles defines certain activities that can each be implemented to a certain extent.

11. The system for managing workflow as described in claim 8, wherein each of the characters can be defined to correspond to a plurality of roles.

12. The system for managing the workflow as described in claim 8, wherein the case information comprises status messages, a plurality of items of workflow step information, and correlative information of documents filed.

13. A method of processing a case under a monitoring system, comprising:
(a) initiating a case and selecting a proper workflow of said case corresponding to essence of said case;
(b) setting related personals handling different stages of said case, corresponding to said workflow;
(c) beginning processing the case by sending a working message to a related personal handling a corresponding stage;
(d) receiving a completion message from the related personal after the related personal finishes said corresponding stage, while also simultaneously sending another working message to another related personal handling another corresponding stage; and
(e) repeating step (d) until all stages of the case have been done; wherein some of said personals are adapted to handle more than one stages which are not continuously arranged with one another.
